(19) United States
(12) Patent Application Publication
(10) Pub. No.: US 2016/0104105 A1
(43) Pub. Date: Apr. 14, 2016

(54) Systems and Methods for Identifying Potential Shipments of Prohibited Goods from Merchants

(71) Applicant: MASTERCARD INTERNATIONAL INCORPORATED, Purchase, NY (US)

(72) Inventor: Justin X. Howe, San Fransicso, CA (US)

(21) Appl. No.: 14/513,718

(22) Filed: Oct. 14, 2014

(51) Int. Cl. G06Q 10/08

(52) U.S. Cl. CPC G06Q 10/0832

(57) ABSTRACT

Systems and methods are provided for use in identifying potential shipments of prohibited goods from merchants in connection with processing transactions relating to the goods. In one exemplary embodiment, a request is initially received, at a computing device, to process a transaction relating to goods provided by a target merchant where the request includes an address or other data associated with the target merchant. A database of merchants that have previously been identified as, or associated with, selling and/or shipping prohibited goods to consumers is then searched for the address or other data associated with the target merchant. When the address or other data associated with the target merchant is in the database, the target merchant is flagged at the computing device and the transaction is declined.

### FIELD

The present disclosure generally relates to systems and methods for use in identifying potential shipments of prohibited goods from merchants, in connection with processing transactions relating to the goods.

### BACKGROUND

This section provides background information related to the present disclosure which is not necessarily prior art.

Goods can be purchased by consumers from merchants in a variety of different ways. When the goods are purchased by the consumers through websites associated with the merchants, the purchased goods are often shipped to the consumers by one or more carriers (e.g., UPS®, FedEx®, DHL®, etc.).

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in identifying a potential shipment of prohibited goods from a merchant, in connection with processing one or more transactions relating to the goods;

FIG. 2 is a block diagram of a computing device, that may be used in the exemplary system of FIG. 1; and

FIG. 3 is an exemplary method, suitable for use with the system of FIG. 1, for identifying the potential shipment of prohibited goods from the merchant, in connection with processing the one or more transactions relating to the goods.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Consumers often enter into transactions with merchants, which are funded by payment accounts, to purchase goods from the merchants. In connection with a portion of these transactions (e.g., e-commerce transactions, etc.), the purchased goods are shipped to the consumers, via one or more carriers (e.g., UPS®, FedEx®, DHL®, etc.). Separately, shipping and/or receiving prohibited goods can result in various unwanted ramifications for carriers and consumers (e.g., legal actions, penalties, fines, confiscation of the goods, etc.). As such, it is desirable to know if potential exists for the goods to be prohibited, before transactions are completed by the consumers and/or the goods are shipped from the merchants. The systems and methods herein identify, and in some cases decline, potential transactions to payment accounts, which involve prohibited merchants and/or shipments of prohibited goods from the merchants, before the transactions are completed and/or the prohibited goods are shipped.

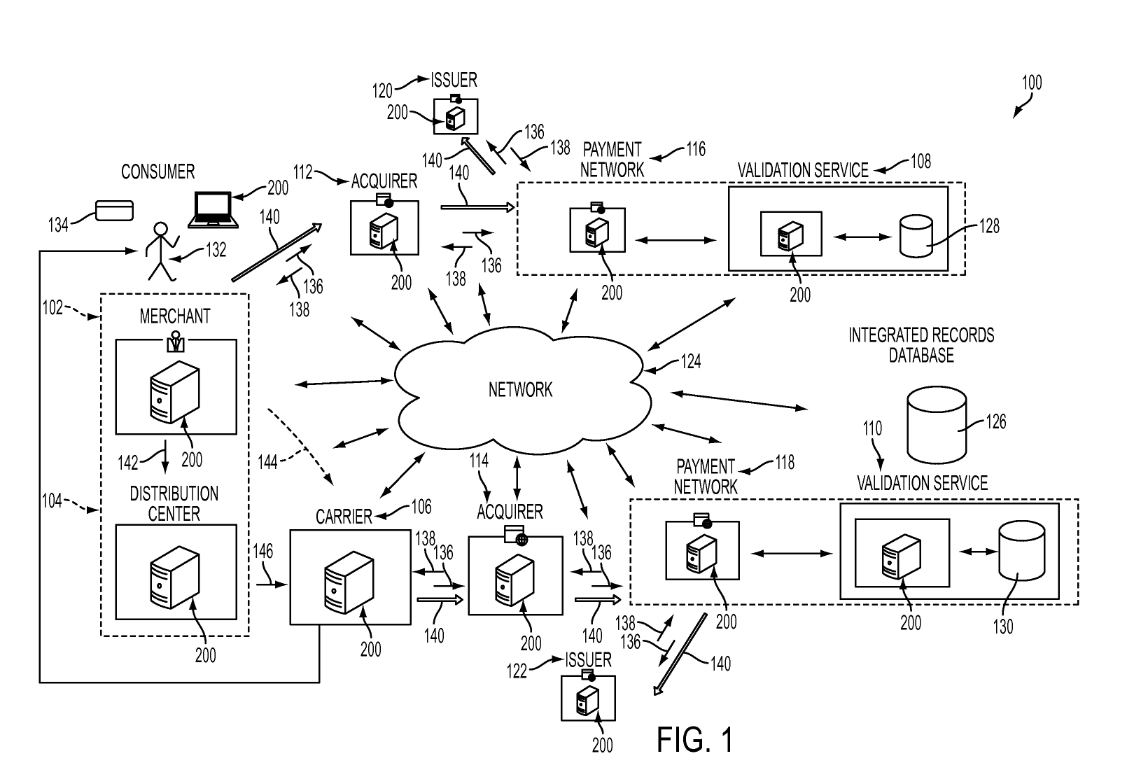

With reference now to the drawings, FIG. 1 illustrates an exemplary system 100, in which one or more aspects of the present disclosure may be implemented. The system 100 is suitable for use in identifying potential shipments of prohibited goods from merchants, in connection with processing transactions relating to the goods. Although components of the system 100 are presented in one arrangement, it should be appreciated that other exemplary embodiments may include the same or different components arranged otherwise, for example, depending on associations between various components of the system 100, etc.

The illustrated system 100 generally includes a merchant 102, a distribution center 104, a carrier 106, validation services 108 and 110, acquirers 112 and 114, payment networks 116 and 118 (e.g., card networks, etc.), and issuers 120 and 122, each coupled to network 124. The network 124 may include, without limitation, a wired and/or wireless network, one or more local area network (LAN), wide area network (WAN) (e.g., the Internet, etc.), mobile network, other network as described herein, and/or other suitable public and/or private network capable of supporting communication among two or more of the illustrated components, or any combination thereof. In one example, the network 124 includes multiple networks, where different ones of the multiple networks are accessible to different ones of the illustrated components in FIG. 1.

With reference to FIG. 1, the validation services 108 and 110 initially collect data, from an integrated records database 126, for merchants that have previously been identified as, or associated with, selling and/or shipping prohibited goods to consumers (i.e., prohibited merchants). Prohibited goods can include, without limitation, false or counterfeit goods (e.g., counterfeit handbags, counterfeit clothing, etc.), illegal goods, such as illegal pharmaceutical goods (e.g., prescription drugs obtained without doctor consultations, from a foreign country, etc.), recreational drugs, firearms, alcohol, hardware that circumvents digital rights management (DRM), regulated goods, etc. In addition, the data collected by the validation services 108 and 110 for the prohibited merchants can include, without limitation, merchant names, merchant addresses, merchant identification numbers (MIDs), and/or any other desired data relating to or identifying the merchants (broadly, merchant data). Once collected, the merchant data is then stored in (e.g., appended to, etc.) merchant databases 128 and 130 associated with the validation services 108 and 110. As such, the merchant databases 128 and 130 include a compilation of merchants, found/collected by the validation services 108 and 110, that pose risks of selling and shipping prohibited goods to consumers.

The integrated records database 126 generically represents various different available sources of merchants identified as, or associated with, selling and/or shipping prohibited goods, including both public and private sources (e.g., sources such as other consumers, other merchants, consumer protection groups, government agencies, court records, etc.). The database 126 may also include indications of the particular types of prohibited goods (and/or general class/category of the goods) associated with the identified merchants (such that the validation services 108 and 110 can also associate a description of the prohibited goods, in the merchant databases 128 and 130, with the identified merchants). Information from the integrated records database 126 can be captured by the validation services 108 and 110, as desired, for example, by manual entry of data from the various sources or by mining websites, databases, etc. associated with such sources. The merchant databases 108 and 110 may be created or updated based on prior violations, proceedings, regulating entity actions, and/or identification of prohibited goods associated with the merchants. In some aspects, the merchant databases 128 and 130 may be generated, at inception, from a listing of merchants whose access to the payment networks 116 and 118 has been terminated for sending prohibited goods in the past. It is contemplated that the validation services 108 and 110 will also track (e.g., continuously monitor, track at select time intervals, etc.) all or a substantial portion of available merchants, through the integrated records database 126, to maintain accuracy of the merchant databases 128 and 130, for example, to identify prohibited merchants for addition to the merchant databases 128 and 130, and to determine if merchants currently included in the merchant databases 128 and 130 should remain in the merchant databases 128 and 130 or can be removed.

In the illustrated system 100, the validation services 108 and 110 are shown separate from the other entities. However, it should be understood that the validation services 108 and 110 could be implemented in combination with one or more of the other entities in the system 100, for example, the carrier 106, the acquirers 112 and 114, the payment networks 116 and 118 (as indicated by the broken lines in FIG. 1), the issuers 120 and 122, etc. such that the features of the validation services 108 and 110 are then implemented through the carrier 106, the acquirers 112 and 114, the payment networks 116 and 118, the issuers 120 and 122, etc., or the validation services 108 and 110 could be implemented in some combination thereof, or with one or more other entities not shown. Further, while two validation services 108 and 110 are illustrated in the system 100, it should be appreciated that a single validation service (e.g., validation service 108, validation service 110, another validation service, etc.) could be used instead, or, alternatively, more than two validation services.

Separately, the merchant 102 (e.g., a target merchant for application of the system 100, etc.) offers goods for sale, for example, at a physical store, through a website (via interfaces associated therewith), etc. A consumer 132 can then purchase the goods from the merchant 102, as desired, by providing payment account information to the merchant 102 (e.g., a payment account number, etc. via a credit card 134 or other payment device, or via login credentials for a previously established purchase account (e.g., an electronic wallet such as MasterPass™, Google Wallet, PayPass, Isis Mobile Wallet®, etc.), etc.). Here, in connection with the purchase, the merchant 102 and the payment network 116 then cooperate to complete the purchase transaction for the goods. For example, the merchant 102 reads the payment account information and communicates, via the network 124, an authorization request to the payment network 116, via the acquirer 112, who is associated with the merchant 102 in the system 100, to process the purchase transaction. The authorization request includes various details of the purchase transaction to help facilitate processing the request (e.g., one or more of a consumer account number, a purchase amount, a product description, a time of the purchase, a date of the purchase, a merchant (or originating) address, a merchant identification number (MID), a consumer (or destination) address, etc. appended to an ISO 8583 message, etc.). The payment network 116, in turn, communicates the authorization request to issuer 120, who is associated with the consumer's payment account in the system 100. The issuer 120 then provides a response to the authorization request (e.g., authorizing or rejecting the request) to the payment network 116, and the response is provided back through the acquirer 112 to the merchant 102. The transaction is then completed, by the merchant 102, if the response includes an approval. In FIG. 1, arrows 136 identify flow of the authorization request and arrows 138 identify flow of the authorization response in the system 100.

When the purchase transaction is approved, the merchant 102 next communicates to the payment network 116, via the acquirer 112, through the network 124, a clearing request (or clearing record) for payment for the purchased goods from the issuer 120 (at a later time after communicating the authorization request, for example, as part of a batch of multiple different approved transactions for a given time period, etc.). In general, the clearing request is communicated when the goods are shipped (such that communication of the clearing request is actually triggered by shipment of the goods). The clearing request also includes the details of the purchase transaction to help facilitate processing the request (e.g., the same details as included in the authorization request appended to an ISO 8583 message, different details from those included in the authorization request, etc.). The payment network 116, in turn, communicates the clearing request to the issuer 120, and funds are then transferred to the acquirer 112 for clearing with the merchant 102. In FIG. 1, arrows 140 identify flow of the clearing request in the system 100.

At about the same time (or at an earlier time, or at a later time), the merchant 102 also communicates, via the network 124, order details for the purchase to the distribution center 104 (e.g., a type of the goods purchased, a quantity of the goods purchased, the consumer's shipping address, etc.) (as indicated by arrow 142), so that the goods can be prepared (e.g., packaged, etc.) for shipment to the consumer 132. In the illustrated system 100, the merchant 102 is shown separate from the distribution center 104. However, it should be understood that the merchant 102 and the distribution center 104 could be implemented in combination (as indicated by the broken lines in FIG. 1), such that the purchased goods are prepared for shipment to the consumer 132 directly at (or by) the merchant 102 without use of the distribution center 104 (as indicated by arrow 144 in FIG. 1).

With continued reference to FIG. 1, in one aspect of the system 100, after the goods are prepared for shipment by the distribution center 104, the distribution center 104 then communicates, via the network 124, a purchase order (PO) to the carrier 106 for shipping the goods to the consumer 132 (as indicated by arrow 146). The PO includes various shipping details for the goods, such as one or more of a payment account number for the distribution center 104, a description of the goods, a requested time/date for shipping the goods, the merchant (or origination) address, the consumer (or destination) address, an address of the distribution center 104 (if different from the merchant address), etc. In this transaction, the distribution center 104 may be viewed as a consumer, and the carrier 106 may be viewed as a merchant. The carrier 106 may include any delivery service entity, such as, for example, UPS®, FedEx®, DHL®, or others in the business of delivering products from one location to another.

The PO transaction between the distribution center 104 and the carrier 106 is then processed for payment in similar fashion to the purchase transaction described above between the consumer 132 and the merchant 102. For example, the carrier 106 initially communicates, via the network 124, an authorization request to the payment network 118 to process the PO transaction, via the acquirer 114, who is associated with the carrier 106 in the system 100. The authorization request includes the details from the PO as well as any additional details needed/required to process the request (e.g., appended to an ISO 8583 message, etc.). The payment network 118, in turn, communicates the authorization request to the issuer 122, who is associated with the distribution center's payment account in the system 100. The issuer 122 then provides a response to the authorization request (e.g., authorizing or rejecting the request) to the payment network 118, and the response is provided back through the acquirer 114. The transaction is then processed, by the carrier 106, if the response includes an approval. In FIG. 1, arrows 136 again identify flow of the authorization request and arrows 138 again identify flow of the authorization response in the system 100.

If the PO transaction is approved, the carrier 106 next communicates, via the network 124, a clearing request to the payment network 118 (again via the acquirer 114) for payment for shipping the goods, from the issuer 122 (e.g., again after communicating the authorization request, for example, as part of a batch of multiple different approved transactions, etc.). The clearing request also includes the details of the PO transaction to help facilitate processing the request (e.g., the same details as included in the authorization request again appended to an ISO 8583 message, different details from those included in the authorization request, etc.). The payment network 118, in turn, communicates the clearing request to the issuer 122, and funds are then transferred to the acquirer 114 for clearing with the carrier 106. In FIG. 1, arrows 140 again identify flow of the clearing request in the system 100. In some aspects, data from the carrier 106 can also be used to update the merchant databases 128 and 130 as appropriate.

In the illustrated system 100, different acquirers 112 and 114, different payment networks 116 and 118, and different issuers 120 and 122 are illustrated in connection with the transactions involving the merchant 102 and the carrier 106. However, it should be appreciated that the same acquirer (e.g., acquirer 112, acquirer 114, another acquirer, etc.), and/or the same payment network (e.g., payment network 116, payment network 118, another payment network, etc.), and/or the same issuer (e.g., issuer 120, issuer 122, another issuer, etc.) could be used in the system 100 instead, for example, where the same acquirer and/or payment network may be associated with both the merchant 102 and the carrier 106, and/or where the same issuer may be associated with both the distribution center 104 and the consumer 132.

In another aspect of the system 100, after the goods are prepared for shipment by the distribution center 104 (or by the merchant 102), the consumer 132 (instead of the distribution center 104 or merchant 102) communicates, via the network 124, a PO to the carrier 106 for shipping the goods to the consumer 132. The PO again includes the various shipping details for the goods (as described above). And, in connection with the PO transaction, the carrier 106 again communicates various requests (e.g., an authorization request, a clearing request, etc.) to the payment network 118, in concert with the acquirer 114 and the issuer 122, to process the PO transaction (in similar fashion to those described above).

With further reference to FIG. 1, for at least one of the various transactions associated with the purchase and shipping of the goods (e.g., the purchase transaction, the PO transaction, etc.), the corresponding one of the payment networks 116 and 118 communicates, via the network 124, the particular clearing request (e.g., the ISO 8583 message associated the clearing request, etc.), or a portion thereof (with some data added or removed, as desired), to the corresponding one of the validation services 108 and 110 to determine if the merchant 102 is a prohibited merchant. Broadly, this may include a request, by the payment networks 116 and 118, to verify (or validate) the merchant 102 (e.g., to determine legitimacy of the merchant 102, to determine if the merchant 102 has been identified as previously violating any laws or other regulations governing the transaction or related transactions, etc.). In some aspects, the payment networks 116 and 118 may provide all clearing requests to the validation services 108 and 110, as part of a real-time verification process for all such requests, especially if, for example, the validation services 108 and 110 are integrated and/or included with the acquirers 112 and 114, the payment networks 116 and 118, and/or the issuers 120 and 122, etc. In other aspects, the payment networks 116 and 118 may communicate only select clearing requests, for example, when a particular threshold is satisfied such as when the clearing requests involve particular merchants, or are associated with particular goods, particular industries, or particular types of transactions (e.g., card-not-present transactions, etc.).

Upon receiving a clearing request from the payment networks 116 and 118, to verify the merchant 102, the validation services 108 and 110 extract desired merchant data (e.g., merchant name, merchant address, MID, etc.) from the request (e.g., from the ISO 8583 message representing the request, etc.), and search the merchant databases 128 and 130 for the merchant 102 (e.g., via a name-based search, an address-based search, an MID-based search, etc.). When the search is complete, the validation services 108 and 110 communicate the search results back to the payment networks 116 and 118. If the merchant 102 is not identified in the databases 128 and 130, the transaction (e.g., the purchase transaction, the PO transaction, etc.) proceeds for processing (e.g., clearing, etc.). However, if the merchant 102 is identified in the merchant databases 128 and 130, the validation services 108 and 110 provide notification to the payment networks 116 and 118, and may also provide notification to one or more of the acquirers 112 and 114, the issuers 120 and 122, the consumer 132, and the carrier 106, indicating that the merchant 102 is prohibited. The payment network 116 and 118 may then decline the corresponding transaction (e.g., deny authorization, refuse clearing, etc.), and/or remove (or take down) the merchant 102 from the payment networks 116 and 118 so the merchant 102 is no longer able to accept payments via payment devices. For example, the payment networks 116 and 118 can reject the clearing request at 140 as it is communicated from the acquirers 112 and 114 to the payment networks 116 and 118. In some embodiments, if the merchant 102 is identified in the merchant databases 128 and 130, the validation services 108 and 110 may also provide the notification to one or more regulatory or enforcement entities, who may then take further disciplinary action against the merchant 102 as appropriate. It should be appreciated that the data included in the clearing request can also be used to update the merchant databases 128 and 130 as appropriate.

While a single merchant 102 is shown in the system 100 of FIG. 1, it should be appreciated that the system 100 can be implemented to verify multiple different merchants with whom the consumer 132 may interact. Likewise, while one consumer 132 is shown in the system 100 of FIG. 1, it should be appreciated that any number of consumers may be included, and accommodated by the system 100.

In addition, in some exemplary embodiments, where the merchant 102 and the distribution center 104 are separate entities, the merchant 102 and/or the carrier 106 may be required to provide data for the distribution center 104 (e.g., name, address, MID, etc.) in connection with any clearing request (or other request) submitted to the payment networks 116 and 118. This ensures that the clearing request includes all available data for the entities involved with the purchased goods. What's more, in these embodiments, it is contemplated that the distribution center 104 is more likely to have a physical address actually associated with the goods being purchased/shipped, as compared to the merchant 102 who may be an online merchant. It is also contemplated that, in general, the number of distribution centers is fewer than the number of corresponding online merchants. As such, in these embodiments, the search performed by the validation services 108 and 110 may be address based, to therefore more likely yield a match to data in the merchant databases 128 and 130 of where the goods to be shipped are actually located.

Further, it should be appreciated that the data included in the various clearing requests processed by the payment networks 116 and 118 may vary depending, for example, on requirements set by the various acquirers 112 and 114 associated with the requests, or on requirements set by regulatory entities tasked to regulate the goods being sold and/or shipped. For most clearing requests, basic transaction data (e.g., MID, transaction date, transaction amount, etc.) may only be needed to process the requests. However, to facilitate inclusion of additional data (e.g., merchant name, merchant address, consumer name, consumer address, etc.) in the clearing requests (or in the authorization requests), to enable proper merchant verification by the validation services 108 and 110, the acquirers 112 and 114 may receive incentives (e.g., lower payment network interchange fees, etc.) if they require the additional data in the clearing requests from the merchant 102 and/or the carrier 106. Similarly, for certain goods or for certain categories of goods (e.g., regulated goods, etc.), regulatory entities may require all clearing requests (or other requests) associated with the goods to include the additional data, in order for the requests to be valid (or not automatically declined).

In one example application of the system 100, the merchant 102 is a pharmaceutical merchant and the goods provided by the merchant 102 include pharmaceutical goods. Here, in connection with a purchase transaction between the consumer 132 and the merchant 102 for the goods, the merchant 102 initially communicates, via the network 124, an authorization request to the payment network 116 (via the merchant's acquirer 112) to process the purchase transaction. When the authorization request is approved, the merchant 102 then communicates to the payment network 116 (at a later time, and again through the merchant's acquirer 112), via the network 124, a clearing request for payment for the purchased goods from the consumer's payment account issuer 120. In this example, the clearing request from the merchant 102 includes an ISO 8583 message with the merchant's address and distribution center's address appended thereto. When received, the payment network 116 communicates, via the network 124, the message to the validation service 108. In response, the validation service 108 extracts the merchant's address and the distribution center's address from the message, and searches the merchant database 128 for the merchant 102 and/or distribution center 104 (via an address-based search) to determine if the merchant 102 or the distribution center 104 is prohibited. If the merchant 102 and distribution center 104 are not identified in the database 128, the request proceeds for clearing. However, if the merchant 102 and distribution center 104 are identified in the merchant database 128, the validation service 108 notifies the payment network 116, which then declines the clearing request and removes (or takes down) the merchant 102 from the payment network 116 so the merchant 102 is no longer able to accept payments via payment devices.

In another example application of the system 100, the merchant 102 is again a pharmaceutical merchant and the goods provided by the merchant 102 again include pharmaceutical goods. Here, in connection with a purchase transaction between the consumer 132 and the merchant 102 for the goods, and after the purchase transaction has been authorized, the merchant 102 communicates, via the network 124, order details for the purchase to the distribution center 104, so that the goods can be prepared for shipment to the consumer 132. The distribution center 104 then communicates, via the network 124, a PO to the carrier 106 for shipping the goods to the consumer 132. Here, the carrier 106 initially communicates, via the network 124, an authorization request to the payment network 118 (via the carrier's acquirer 114) to process the PO transaction. When the authorization request is approved, the carrier 106 then communicates to the payment network 118 (at a later time, and again through the acquirer 114), via the network 124, a clearing request for payment for shipment of the goods from the distribution center's payment account issuer 122. In this example, the clearing request from the carrier 106 again includes an ISO 8583 message with the merchant's address and distribution center's address appended thereto. When received, the payment network 118 communicates, via the network 124, the message to the validation service 110. In response, the validation service 110 extracts the merchant's address and the distribution center's address from the message, and searches the merchant database 130 for the merchant 102 and distribution center 104 (via an address-based search) to determine if the merchant 102 or the distribution center 104 is prohibited. If the merchant 102 and distribution center 104 are not identified in the database 130, the request proceeds for clearing. However, if the merchant 102 and distribution center 104 are identified in the merchant database 130, the validation service 110 notifies the payment network 118, which then declines the clearing request and removes (or takes down) the merchant 102 from the payment network 118 so the merchant 102 is no longer able to accept payments via payment devices.

In the illustrated system 100, the clearing requests are described as being communicated to the validation services 108 and 110 for use in determining if the merchant 102 or the distribution center 104 is prohibited. In other exemplary embodiments, authorization requests (or other requests) may be communicated to the validation services 108 and 110 for use in determining if the merchant 102 or the distribution center 104 is prohibited. Collectively, such requests, communicated to the validation services 108 and 110, may be referred to as transaction requests, validation requests, verification requests, etc. In connection with the authorization requests, for example, the payment networks 116 and 118 can override approvals of the authorization requests and make them declines, at responses 138 between the payment networks 116 and 118 and the acquirers 112 and 114, if the merchant 102 is a prohibited merchant.

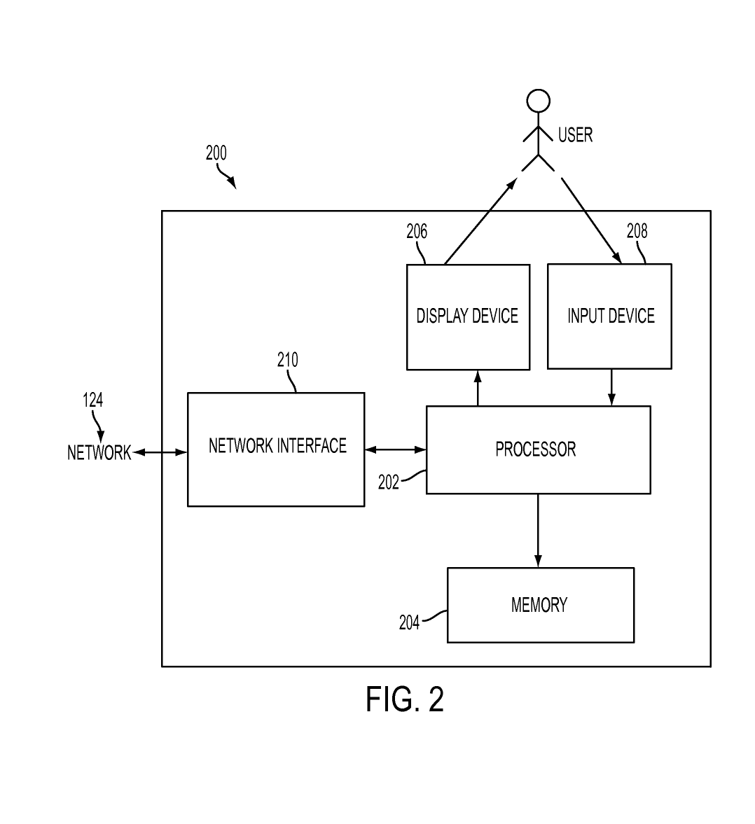

FIG. 2 illustrates an exemplary computing device 200. In the exemplary embodiment of FIG. 1, each of the merchant 102, the distribution center 104, the carrier 106, the validation services 108 and 110, the payment networks 116 and 118, and the consumer 132 are illustrated as including or being associated with a computing device 200. The computing device 200 may include, for example, one or more servers, personal computers, laptops, tablets, PDAs, telephones (e.g., cellular phones, smartphones, other phones, etc.), POS terminals, combinations thereof, etc. as appropriate.

The system 100, and its components, however, should not be considered to be limited to the computing device 200, as described below, as different computing devices and/or arrangements of computing devices may be used. In addition, different components and/or arrangements of components may be used in other computing devices. Further, in various exemplary embodiments the computing device 200 may include multiple computing devices located in close proximity, or distributed over a geographic region. Additionally, each computing device 200 may be coupled to a network (e.g., the Internet, an intranet, a private or public LAN, WAN, mobile network, telecommunication networks, combinations thereof, or other suitable network, etc.) that is either part of the network 124, or separate therefrom.

As shown in FIG. 2, the exemplary computing device 200 includes a processor 202 and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, flash drives, hard disks, and/or any other type of volatile or nonvolatile physical or tangible computer-readable media. The memory 204 may be configured to store, without limitation, data relating to merchants in the merchant databases 128 and 130, data relating to the merchant 102, data relating to the distribution center 104, transaction data, shipping data, and/or other types of data suitable for use as described herein, etc. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

In the exemplary embodiment, the computing device 200 includes an output device 206 that is coupled to the processor 202. The output device 206 outputs to a user (e.g., the consumer 132, individuals associated with the merchant 102, the distribution center 104, the carrier 106, the validation services 108 and 110, the payment networks 116 and 118, etc.) by, for example, displaying, audibilizing, and/or otherwise outputting information such as, but not limited to, details of various goods, offers associated with the goods, transaction data, shipping data, and/or any other type of data. It should be further appreciated that, in some embodiments, the output device 206 comprises a display device such that various interfaces (e.g., webpages, etc.) may be displayed at computing device 200, and in particular at the display device, to display such information, etc. And in some cases, the computing device 200 may cause the interfaces to be displayed at a display device of another computing device, including, for example, a server hosting a website having multiple webpages, etc. With that said, output device 206 may include, without limitation, a liquid crystal display (LCD), a light-emitting diode (LED) display, an organic LED (OLED) display, an “electronic ink” display, speakers, combinations thereof, etc. In some embodiments, output device 206 includes multiple devices.

The computing device 200 also includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both output device 206 and input device 208.

In addition, the illustrated computing device 200 also includes a network interface 210 coupled to the processor 202 and the memory 204. The network interface 210 may include, without limitation, a wired network adapter, a wireless network adapter, a mobile telecommunications adapter, or other device capable of communicating to one or more different networks, including the network 124. In some exemplary embodiments, the computing device 200 includes the processor 202 and one or more network interfaces incorporated into or with the processor 202.

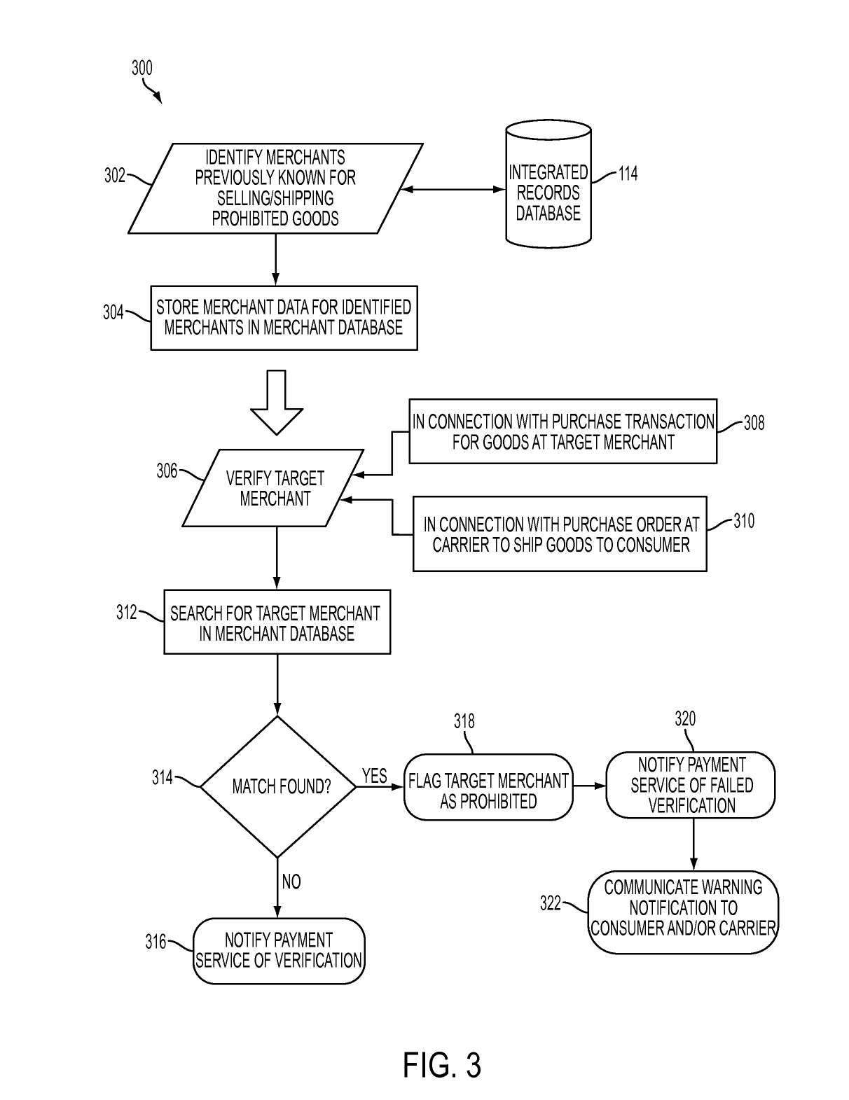

FIG. 3 illustrates an exemplary method at 300 for identifying a potential shipment of prohibited goods from a merchant, in connection with processing one or more transactions relating to the goods. In so doing, the method 300 can help confirm that the purchased goods aren't prohibited and can be shipped legally to consumers. The exemplary method 300 is described as implemented in the validation services 108 and 110 of the system 100, with further reference to the merchant 102, the distribution center 104, the carrier 106, the acquirers 112 and 114, the payment networks 116 and 118, the issuers 120 and 122, and the consumer 132. As described above, in at least some embodiments, the validation services 108 and 110 may be included with the payment networks 116 and 118 (again as illustrated by the broken lines in FIG. 1), and/or with other entities, shown or not shown in FIG. 1. In addition, in some embodiments, the same acquirer (e.g., acquirer 112, acquirer 114, another acquirer, etc.), and/or the same payment network (e.g., payment network 116, payment network 118, another payment network, etc.), and/or the same issuer (e.g., issuer 120, issuer 122, another issuer, etc.) may be used where the same acquirer and/or payment network is associated with both the merchant 102 and the carrier 106, and/or where the same issuer is associated with both the distribution center 104 and the consumer 132.

Further, for purposes of illustration, the exemplary method 300 is described herein with reference to the computing device 200. In addition, just as the methods herein should not be understood to be limited to the exemplary system 100, or the exemplary computing device 200, the systems and the computing devices herein should not be understood to be limited to the exemplary method 300.

As shown in FIG. 3, the validation services 108 and 110, via their computing devices 200, initially identify merchants at 302, from the integrated records database 126, which have previously been identified as, or associated with, selling and/or shipping prohibited goods to consumers. All available merchants, through the integrated records database 126, are tracked to identify/determine which, if any, may be prohibited. Merchant data for the identified merchants is then collected, for example, by web scraping of websites or manual data collection, and stored electronically in the merchant databases 128 and 130 at 304, with the particular prohibited goods (and/or general class/category of goods) triggering identification of the various merchants appended thereto. As part of collecting and storing the merchant data, the validation services 108 and 110, at their computing devices 200 (e.g., through the processors 202 of their computing devices 200, etc.), also index the merchant data, to help categorize the data and allow for subsequent retrieval and use. Such indexing may be based on a variety of different information including, for example, merchant name, merchant address, MID, etc.

When desired to determine if the merchant 102 (e.g., the target merchant, etc.) is a prohibited merchant (broadly, when desired to verify or validate the merchant 102), a request is submitted to, and received by, the validation services 108 and 110, at 306, via the network 124. In the illustrated method 300, the request originates from one of the payment networks 116 and 118, and corresponds to one of the clearing requests (or at least a portion thereof) involving either the purchase transaction for the goods at the merchant 102, at 308, or the PO transaction at the carrier 106 for shipping the goods, at 310. As described above, the clearing request includes various data relating to the purchase of the goods or the shipment of the goods (e.g., MID, transaction date, transaction amount, etc.) as well as, in the illustrated embodiment, various merchant and consumer data (e.g., one or more of merchant name, merchant address, consumer name, consumer address, etc.) appended thereto. In other exemplary embodiments, the request may correspond to one of the authorization requests associated with either the purchase transaction for the goods at the merchant 102 or the PO transaction for shipping the goods at the carrier 106.

Once the clearing request is received by the validation services 108 and 110 (at their computing devices 200), the validation services 108 and 110 initially identify the merchant 102 in the request (e.g., extract the desired merchant data from the request, etc.), and then search in the merchant databases 128 and 130, at 312, for the identified merchant 102. In particular, the processor 202 of the respective computing device 200, searches in the corresponding one of the merchant databases 128 and 130 for keywords associated with the merchant 102, for example, the merchant's name (e.g., the merchant's legal name, the merchant's business name (e.g., fictitious name, doing business as (DBA) name, etc.), the merchant's address, the merchant's MID, other (e.g., prior) business names for the merchant 102, names of divisions or other companies associated with the merchant 102, etc. to determine if the merchant 102 is in the databases 128 and 130 and, thus, poses a risk of selling and/or shipping prohibited goods.

When the merchant 102 is not included in the merchant databases 128 and 130 (i.e., a match of the target merchant 102 is not found), at 314, the validation services 108 and 110 notify the payment networks 116 and 118, at 316, that the merchant 102 is valid (or verified). The payment networks 116 and 118 then proceed with the transaction for clearing, etc. However, when the search, at 312 and 314, identifies the merchant 102 in the merchant databases 128 and 130, the merchant 102 is flagged as prohibited, at 318, by the validation services 108 and 110, at their computing devices 200, and the validation services 108 and 110 notify the payment networks 116 and 118, at 320, that the merchant 102 is prohibited. In addition, a warning notification (or message (e.g., via email, mail, phone, etc.)) is sent by the validation services 108, at 322, via the network 124 to one or more of the acquirers 112 and 114, the issuers 120 and 122, the consumer 132, and the carrier 106 indicating that the merchant 102 is prohibited. The transaction relating to the transaction request is then also declined by the payment networks 116 and 118, in the illustrated method 300. In addition, in some aspects, the payment networks 116 and 118 also remove, or take down, the merchant 102 so that the merchant 102 is no longer able to accept payments via payment devices. The flag for the merchant 102 and/or the warning notification associated therewith may then also be stored in memory 204 of the corresponding computing device 200, or otherwise stored, in one or more embodiments.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving a request to process a transaction relating to goods provided by a target merchant where the request including an address associated with the target merchant; (b) identifying merchant data, associated with the target merchant, from the request; (c) searching in a database of merchants that have previously been identified as, or associated with, selling and/or shipping prohibited goods to consumers for the address associated with the target merchant; (d) flagging the target merchant, at the computing device when the address associated with the target merchant is in the database; (e) declining the transaction when the address associated with the target merchant is in the database; (f) communicating a warning to at least one of a consumer associated with the transaction request and a carrier shipping the goods when the flag is generated for the target merchant, where the warning includes at least an identification of the target merchant and an indication that the goods are prohibited; and (g) not declining the transaction when the address associated with the target merchant is not in the database.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for identifying potential shipments of prohibited goods from merchants, in connection with processing transactions relating to the goods, the system comprising:
a memory including a database of merchants that have previously been identified as, or associated with, selling and/or shipping prohibited goods to consumers, merchant data being associated with each of the merchants in the database; and
a processor coupled to the memory, the processor configured to execute instructions, stored in the memory, to cause the processor to:
identify merchant data, associated with a target merchant, from a request to process a transaction relating to goods provided by the target merchant;
search in the database for the merchant data associated with the target merchant;
generate a flag for the target merchant when the merchant data associated with the target merchant is in the database; and
communicate a warning to at least one of a consumer associated with the transaction and a carrier shipping the goods when the flag is generated for the target merchant, the warning including at least an identification of the target merchant and an indication that the goods are prohibited.

2. The system of claim 1, wherein the processor is further configured to execute instructions stored in the memory to cause the processor to decline the transaction when the merchant data associated with the target merchant is in the database.

3. The system of claim 1, wherein the transaction includes a purchase transaction between the consumer and the target merchant for the goods.

4. The system of claim 3, wherein the request is selected from the group consisting of an authorization request to approve the purchase transaction between the consumer and the target merchant and a clearing request to fund the purchase transaction between the consumer and the target merchant.

5. The system of claim 1, wherein the transaction includes a purchase order transaction at the carrier to ship the goods to the consumer.

6. The system of claim 5, wherein the request is selected from the group consisting of an authorization request to approve the purchase order transaction and a clearing request to fund the purchase order transaction.

7. The system of claim 1, wherein the processor is further configured to execute instructions stored in the memory to cause the processor to not decline the transaction when the merchant data associated with the target merchant is not in the database.

8. The system of claim 1, wherein the processor is further configured to execute instructions stored in the memory to cause the processor to append one or more merchants to the database when the one or more merchants are identified as, or associated with, shipping prohibited goods to consumers.

9. The system of claim 1, wherein the target merchant is a pharmaceutical merchant and the goods include pharmaceutical goods, and wherein the request includes a clearing request to fund one of a purchase transaction between the pharmaceutical merchant and a consumer for the pharmaceutical goods and a purchase order transaction at a carrier to ship the pharmaceutical goods to the consumer.

10. The system of claim 1, wherein the merchant data is selected from the group consisting of merchant name, merchant address, and merchant identification number.

11. A computer-implemented method for use in identifying potential shipments of prohibited goods from merchants in connection with processing transactions relating to the goods, the method comprising:
receiving, at a computing device, a request to process a transaction relating to goods provided by a target merchant, the request including an address associated with the target merchant;
searching, in a database of merchants that have previously been identified as, or associated with, selling and/or shipping prohibited goods to consumers, for the address associated with the target merchant; and
when the address associated with the target merchant is in the database:
flagging the target merchant, at the computing device; and
declining the transaction.

12. The method of claim 11, further comprising not declining the transaction when the address associated with the target merchant is not in the database.

13. The method of claim 11, wherein the transaction includes a purchase transaction between a consumer and the target merchant for the goods.

14. The system of claim 13, wherein the request is selected from the group consisting of an authorization request to approve the purchase transaction between the consumer and the target merchant and a clearing request to fund the purchase transaction between the consumer and the target merchant.

15. The system of claim 11, wherein the transaction includes a purchase order transaction at a carrier to ship the goods to a consumer.

16. The system of claim 15, wherein the request is selected from the group consisting of an authorization request to approve the purchase order transaction and a clearing request to fund the purchase order transaction.

17. The merchant of claim 11, wherein the target merchant is a pharmaceutical merchant, and wherein the transaction involves shipping pharmaceutical goods from the address associated with the pharmaceutical merchant to an address associated with the consumer.

18. A non-transitory computer readable media comprising computer-executable instructions that, when executed by at least one processor, cause the at least one processor to:
identify an address, associated with a target merchant, from a request relating to a transaction associated with goods provided by the target merchant;
search in a database for the address of the target merchant;
when the address associated with the target merchant is in the database:
generate a flag for the target merchant;
decline the transaction; and
communicate a warning to at least one of a consumer associated with the transaction and a carrier shipping the goods when the flag is generated for the target merchant, the warning including at least an identification of the target merchant and an indication that the goods are prohibited; and
when the address associated with the merchant is not in the database, not decline the transaction.

19. The non-transitory computer readable media of claim 18, wherein the transaction includes a purchase transaction between the consumer and the target merchant for the goods; and
wherein the request is selected from the group consisting of an authorization request to approve the purchase transaction between the consumer and the target merchant and a clearing request to fund the purchase transaction between the consumer and the target merchant, the request including at least part of an ISO 8583 message associated with the selected one of the authorization request and clearing request.

20. The non-transitory computer readable media of claim 18, wherein the transaction includes a purchase order transaction at the carrier to ship the goods to the consumer; and
wherein the request is selected from the group consisting of an authorization request to approve the purchase order transaction and a clearing request to fund the purchase order transaction, the request including at least part of an ISO 8583 message associated with the selected one of the authorization request and clearing request.
